(19) United States
(12) Patent Application Publication
(10) Pub. No.: US 2008/0208557 A1
(43) Pub. Date: Aug. 28, 2008

(54) SIMULATION METHOD AND SIMULATION SYSTEM

(76) Inventor: Tomoaki Katano, Kanagawa (JP)

Correspondence Address: MCDERMOTT WILL & EMERY LLP, 600 13TH STREET, NW, WASHINGTON, DC, 20005-3096, US

(21) Appl. No.: 12/030,559

(22) Filed: Feb. 13, 2008

(30) Foreign Application Priority Data
Feb. 26, 2007 (JP) P. 2007-045446

(51) Int. Cl. G06G 7/48

(52) U.S. Cl. 703/16

(57) ABSTRACT

A simulation executing unit 1, an execution list forming unit 2, and an execution list 3 are prepared. The simulation executing unit 1 does not execute all of function models 4 every cycle, but executes only such a process operation described in the execution list 3 formed by the execution list forming unit 2. Upon receipt of notification as to a status change sent from each of hardware, the execution list forming unit 2 dynamically forms the execution list 3 of process operations which are executed every cycle in conjunction with the status change. As a result, the simulation executing unit 1 performs such a process operation suitable for the status change every cycle so as to perform a simulation in a high speed.

### BACKGROUND OF THE DISCLOSURE

1. Field of the invention

The present invention is related to a simulation technique of a system LSI containing respective functions of hardware such as processors and DSPs (Digital Signal Processors) in the beginning. More specifically, the present invention is directed to a technique for performing simulations based upon a cycle base including a time concept of a clock when system level languages are employed are typically known as C/C++ and SystemC.

2. Description of the related art

In conventional RTL (Register Transfer Level) descriptions by using HDL (Hardware Description Language) languages (Verilog and VHDL), simulations can be executed in synchronism with each of events. However, in connection with increases of scales as to system LSIs, in large-scaled simulations by which entire system LSIs are operated, a total number of events is increased. As a result, in the RTL description levels, there is such a problem that simulation speeds are lowered.

In order to solve the above-described problem, presently, such mechanisms capable of realizing high-speed simulations by utilizing system level languages such as SystemC. However, even in simulations with employment of the system level languages, when simulations are carried out based upon a cycle base including a time concept, function models of each of hardware are executed every cycle.

For instance, in accordance with descriptions by the system level language of SystemC, in such a case that time concepts of clocks are employed when simulations are carried out, while SC_THREAD/SC_CTHREAD/SC_METHOD is utilized, process operations are carried out as process operations executed in synchronism with the clocks are defined as processes (refer to, for instance, non-patent publication 1).

Non-patent publication 1: Japanese Book entitled “System Design based upon SystemC” written by Thorsten Grotker, Stan Liao, Grant Martin, and Stuart Swan, translated by M. Kakimoto, M. Kawarabayashi, and T. Hasegawa, published by MARUZEN K. K., published on Jan. 30, 2003

Since simulations using the system languages are carried out, simulation descriptions of cycle bases can be easily made. Also, operation descriptions of each of hardware on the cycle base may be described every hardware model.

However, while scales of system LSIs are furthermore increased and scales of software processing operations are increased which are wanted to be executed by simulators of the system LSI, process operations to be executed in descriptions of cycle bases are increased, so that highspeed executions of simulations are desired.

For instance, in an example by employing the above-described SystemC, such a process registered in SC_THREAD is necessarily executed in synchronism with a rising edge (otherwise, falling edge) of a clock set to SC_THREAD. As a consequence, if a total number of models is increased which constitute subjects of a system LSI, then a total number of processes are increased by the increased models.

If the present load condition is not such a maximum load condition that all of the blocks are operated, then the respective processes where operations of the respective models have been described are executed. However, there are many cases that operations which may give influences to a system are not performed. Even in such a case, since the process is carried out, calls of the processes of the respective models may constitute an overhead of a simulation.

As a consequence, in the conventional simulation method, in each of the process operations which is executed in synchronism with each of the cycles, the operation must be changed by checking the status of the system, or the execution must be controlled by checking the status of the system in the main routine where the respective process operations are executed.

FIG. 9 shows a flow chart for describing the conventional simulation system for changing the operation by checking the status of the system. That is, in a main routine process operation shown in FIG. 9(a), the system is initialized (step S41); a judgment is made whether or not the simulation is continuously performed (step S42); and when the simulation is continuously performed (Yes), an execution of a hardware process operation 1 is judged (step S43).

In the step S43, the process operation of the conventional simulation method is advanced to the hardware process operation 1 indicated in FIG. 9(b), and then, a judgment is made whether or not the present process status is a process executable status (step S51); and when the present process status is the process executable status (Yes), the hardware process operation 1 is executed (step S52).

Similarly, in a hardware process operation 2 (step S44) and another hardware process operation 3 (step S45), the process operation of the conventional simulation method is advanced to the hardware process operations 2 and 3 shown in FIG. 9(b), in which a judgment is made whether or not the present process status is a process executable status (step S51); and if the present process status is the process executable status (Yes), then the hardware process operation 2, or 3 is executed (step S52).

Also, FIG. 10 indicates a flow chart of the conventional simulation method in which the status of the system in the main routine for executing the respective process operations is checked so as to control the executions. That is, in a main routine process operation shown in FIG. 10(a), the system is initialized (step S61); a judgment is made whether or not the simulation is continuously performed (step S62); and further, a judgment is made whether or not a hardware process operation 1 is under process executable status (step S63); and also, when the hardware process operation 1 is under the process executable status (Yes), the hardware process operation 1 is carried out (steps S64 and S71).

Similarly, a judgment is made whether or not the hardware process operation 2 is under process executable status (step S65); and when the hardware process operation 2 is under the process executable status (Yes), the hardware process operation 2 is carried out (steps S66 and S71). Moreover, a judgment is made whether or not the hardware process operation 3 is under process executable status (step S67); and when the hardware process operation 3 is under the process executable status (Yes), the hardware process operation 3 is carried out (steps S68 and S71).

In contrast to the above-described conventional simulation methods, as methods capable of realizing high speeds of simulations, there is such a method for realizing a simulation having no time concept, while the time concept is abstracted. In a simulation of an assembling system in which real-time process operations at developing stages after a hardware structure has been defined as a system LSI are mainly executed, a time concept constitutes an important element; and there is another important that temporal management by a timer, and periodic process operations are simulated in high precision.

Abstracting of the time concept has been realized by changing the process operations themselves of the main routines shown in FIG. 9 and FIG. 10. A description will now be made of a comparison between such a case that the time concept is not abstracted and such a case that the time concept is abstracted. When the time concept is not abstracted, for instance, in the simulation case of FIG. 9, in order to execute the hardware process operation 1 (step S43) 5 times, the process operation of this conventional simulation method is required to pass through the loop (defined from steps S42 to S45) from the simulation continuation (step S42) of the main routine 5 times. Assuming now that this loop corresponds to a process operation of 1 cycle of the hardware, such an operation that the hardware process operation 1 is carried out 5 times corresponds to process operations which are executed for 5 cycles. In other words, in this case, while a status every cycle is held, the process operation is advanced to 5 cycles.

In contrast to the above-explained case, in such a case that the time concept is abstracted, the hardware process operation 1 for 5 times are carried out when a first hardware process operation is carried out. In this case, a total number of loops of the main routine may be reduced, so that the simulation can be executed in a high speed. However, a hardware status for each of these cycles cannot be realized.

On the other hand, in the conventional simulation methods, simulation speeds are lowered due to other factors. In this case, a description is made of a conventional simulation method. FIG. 11 describes a block structure of a system LSI which constitutes a simulation subject. This simulation subject system LSI is arranged by a processor (CPU) 5, a memory 11, a clock generator 9, a reset controller 10, a hardware engine“A” 6, another hardware engine“B” 7, and another hardware engine“C” 8.

Firstly, an apparatus for performing a simulation in accordance with the conventional method is represented in FIG. 12. A simulation executing unit 1 executes each of the hardware engines 6, 7, 8 with the CPU 5 every cycle.

FIG. 13 describes a process flow operation of the simulation executing unit 1. When the simulation is commenced, an initializing operation (step S81) is carried out, and thereafter, a main routine is executed. In the main routine, the CPU model 5 acquires an instruction on the memory 11, and then, executes the acquired instruction in a process operation (step S83) of the CPU execution.

When each of the hardware engines 6, 7, 8 is executed, the respective hardware engines 6, 7, 8 execute respective defined process operations in accordance with set values by the CPU 5 (steps S84, S85, S86). It is so assumed that while the clock generator 9, the reset controller 10, and the memory 11 do not execute execution process operations every cycle, the clock generator 9, the reset controller 10, and the memory 11 execute the process operations only when an access is issued from the CPU 5.

It is also assumed that upon receipt of the access issued from the CPU 5, the clock generator 9 controls clock supply statuses of the respective hardware engines 6, 7, 8 based upon a write value thereof. It is further assumed that upon receipt of the access from the CPU 5, the reset controller 10 releases resetting conditions of the respective hardware engines 6, 7, 8 based upon a write value thereof.

It is also assumed that when each of the hardware engines 6, 7, 8 is executed, the respective hardware engines 6, 7, 8 check a setting status of this clock generator 9 and a setting status of the reset controller 10; and if the clock has been supplied and the resetting condition has been released, then the respective hardware engines 6, 7, 8 execute the defined process operations. FIG. 1-4 describes a process flow operation of the hardware engines 6, 7, 8 at this time.

In the conventional simulation executing method, as shown in FIG. 13, such calling process operations are executed every cycle, namely, an execution of the CPU 5 (step S83); an execution of the hardware engine“A” 6 (step S84); an execution of the hardware engine“B” 7 (step S85); and an execution of the hardware engine“C” 8 (step S86).

It should be understood that the above-described “cycle” implies such a unit that a time is advanced on a simulation, while the simulation is executed every cycle. In the flow chart of FIG. 13, such a simulation process defined from the judgment as to the simulation continuation (step S82) up to the execution of the hardware engine“C” 8 (step S86), which is executed by 1 time, constitutes 1 cycle.

As shown in the flow operation of FIG. 14, while the process operations of the respective hardware engines 6, 7, 8 are executed, a clock status is confirmed (step S91) and a resetting status is confirmed (step S92). If the clock has been supplied (Yes) and the resetting status has been released (Yes), then the respective hardware engines 6, 7, 8 perform actual process operations (step S93).

As previously explained, in the conventional simulation method, in the main routine, the process operation is performed even with respect to such a hardware that the actual process operation is not executed, and in the process operation which has been executed, such process operations for confirming the clock supply status and the resetting status occur.

Although there are only three pieces of hardware engines as the subjects in this example, if a total number of such hardware engines is increased, then a time duration required for executing this process operation is increased. As a result, lowering of a simulation speed may occur.

### SUMMARY OF THE INVENTION

The present invention has been made to solve the above-described problems of the conventional simulation methods, and therefore, has an object to provide a simulation method and a simulation system, capable of realizing a high-speed simulation without lowering a simulation speed due to an overhead.

Also, the present invention has another object to provide a simulation method and a simulation system, capable of reducing an adverse influence caused by an increase in a scale of a system LSI, while simulation precision of a cycle base is maintained.

In order to solve the above-described problem, namely, lowing of the simulation speed, in first invention, in addition to a step for executing a simulation cycle, another step is provided by which a list for executing a simulation cycle is dynamically formed in response to a status change of each of hardware. When the simulation cycle is executed, only a simulation item described in the formed list is executed. As a result, while eliminating the executions of the respective function units and checking of the status which have been carried out every simulation cycle in the conventional simulation method, the simulation can be executed in a high speed.

As a result, since the execution list of the simulation is dynamically formed in response to the changes in the statuses of the hardware, for instance, the clock setting operation by the access from the software (CPU) and the initiation setting operation to the hardware block, while the simulation precision of the cycle base is maintained, the influence caused by the scale increase of the system LSI can be reduced, so that the simulation can be carried out in the high speed.

In second invention, since forming of the execution list of the simulation described in the above-explained first invention is loaded to a function block of a clock generator, a simulation of multi-cycles in a frequency division and a gated clock can be executed in a high speed.

When the CPU sets the clock, the content of the execution list is updated. When a simulation for each cycle is carried out, only an execution process operation of the execution list is carried out without checking the status of the clock.

Third invention corresponds to a method for forming an execution list by checking a status of a clock and a resetting status, while the clock generator and a reset controller are contained in the simulation system.

Fourth invention is arranged as follows: That is, while a function block for forming an execution list is prepared which is independent from the function block of the simulation, a simulation execution list is formed. In the second invention and the third invention, such an arrangement for forming the execution list based upon the clock status and the resetting status has been employed. In the case that the execution list of the simulation is changed based upon any other status changes than the above-described status changes, and/or the execution list is formed based upon a plurality of conditions, an independent control block is prepared; the control block receives notification as to a necessary status change from each of the function blocks; the control block manages these statuses; and then, a simulation execution list is formed.

With respect to the notification about the status changes issued from the respective function blocks, the following notification may be conceived, namely, notification about a sleep mode issued from the CPU; notification about a resetting status in the reset controller; notification as to setting of a gated clock and of an operation enable, which are specific to each of hardware engines.

Fifth invention corresponds to such a method that while notification issued when the CPU is brought into a sleep status and notification issued when the CPU is recovered from the sleep status are defined as status changing points, a simulation speed under sleep condition of the CPU is increased. In this case, when an instruction for entering the CPU into the sleep status is executed during the simulation, the content of the above-described execution list is updated so as to delete the CPU from this execution list.

In the case of the conventional system simulations, there are many methods in which the executions of the CPUs are mainly carried out so as to perform the system simulations. In this case, the sleep status could not be simulated in the beginning, or even in such a case that the sleep status could be simulated, even when the CPU is brought into the sleep status, the routine of the CPU must be executed. Since the above-described method of the fifth invention is employed, the effect for improving the simulation speed under such a condition that the CPU is under the sleep status can be furthermore increased.

In accordance with the present invention, while the simulation precision of the cycle level is maintained, the simulation as to the system LSI can be carried out in the high speed. In particular, such a large scaled and long time simulation which contains OS, device drivers, and middleware with employment of a presently available large-scaled and complex system LSI, and in which a block operated as a system is changed by setting the respective function blocks can be carried out in such a high speed approximated to the actual speed.

Since forming of the execution list in the simulation method of the present invention corresponds to such a process operation which is not employed in the conventional simulation method, execution cost is increased by conducting this execution of the list formation. However, in such a case that a total execution time of a main routine is considerably larger than a total time of status changes, the entire speed improvement which may exceed the execution cost can be achieved.

For instance, the main routine is executed every time the simulation cycle is advanced. As to a total number of accesses to the clock generator, this total access number becomes only such a total number when the CPU actually accesses the clock generator, and thus, an occurrence frequency becomes very low. As a consequence, since the execution process operation per cycle is decreased based upon this method, there is a great advantage when the simulation is carried out in the high speed.

### BRIEF DESCRIPTION OF THE DRAWINGS

FIG. 1 is a schematic diagram for explaining a simulation system according to an embodiment mode of the present invention.

FIG. 2 is a block diagram (1) of the simulation system according to the embodiment mode of the present invention.

FIG. 3 is a diagram for representing an example as to an execution list employed in the simulation system according to the embodiment mode of the present invention.

FIG. 4 is a diagram for showing process flow operations by a simulation method according to the embodiment mode of the present invention.

FIG. 5 is a diagram (1) for indicating process flow operations of hardware engines according to the embodiment mode of the present invention.

FIG. 6 is a block diagram (2) of the simulation system according to the embodiment mode of an present invention.

FIG. 7 is a diagram (2) for indicating process flow operations of hardware engines according to the embodiment mode of the present invention.

FIG. 8 is a block diagram (3) of the simulation system according to the embodiment mode of an present invention.

FIG. 9 is the diagram (1) for showing the process flow operations by the conventional simulation method.

FIG. 10 is the diagram (2) for indicating the process flow operations by the conventional simulation method.

FIG. 11 is a structural diagram of a system LSI which is utilized in the embodiment mode of the present invention.

FIG. 12 is a diagram for showing the apparatus for embodying the conventional simulation method.

FIG. 13 is the diagram for showing the process flow operations by the conventional simulation method.

FIG. 14 is the diagram for indicating the process flow operations of the hardware engines in the conventional simulation method.

### DESCRIPTION OF THE PREFERRED EMBODIMENTS

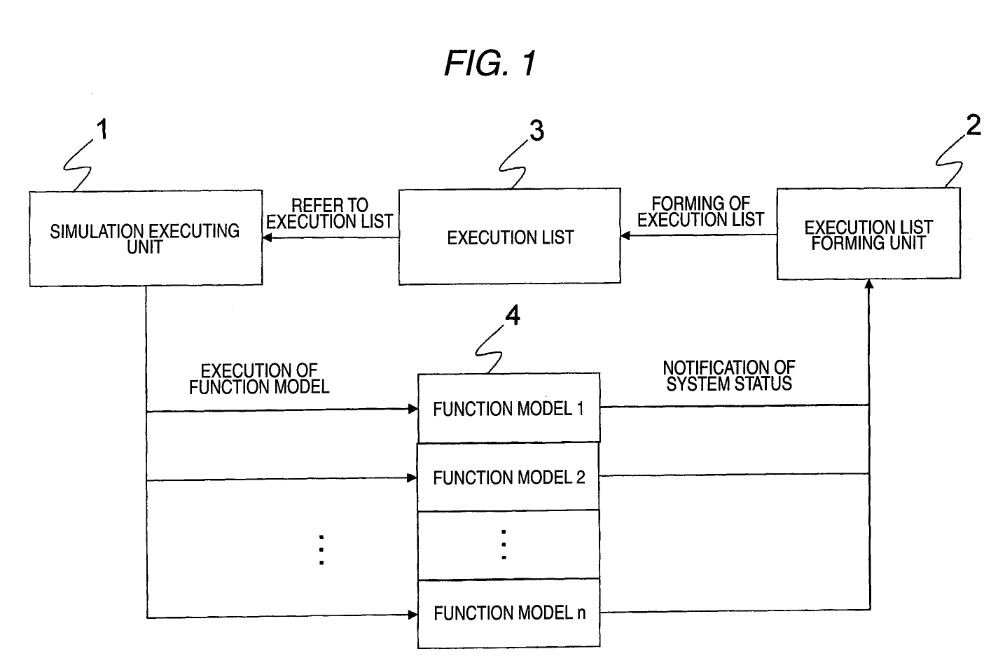

FIG. 1 is a diagram for representing an example as to an apparatus for realizing a simulation method according to an embodiment mode of the present invention. A simulation executing unit 1 shown in this drawing executes process operations of respective function models 1 to “n.” The simulation executing unit 1 executes the respective function models 4 every cycle, so that operations of a system LSI are simulated.

An execution list forming unit 2 receives notification as to status changes issued from the function models 4, and checks statuses of the respective function models 1 to “n” so as to form an execution list 3. The execution list 3 corresponds to such a list about information indicative of such a function model to which a simulation should be carried out, namely, a list of information representative of a function model which is operated so as to give an influence to a system under a certain status. The simulation executing unit 1 does not execute all of the function models 4 every cycle, but executes only a process operation of such a function model 4 which is described in the execution list 3 formed by the execution list forming unit 2.

Next, a description is made of modes for embodying first invention and second invention by improving the conventional simulation methods.

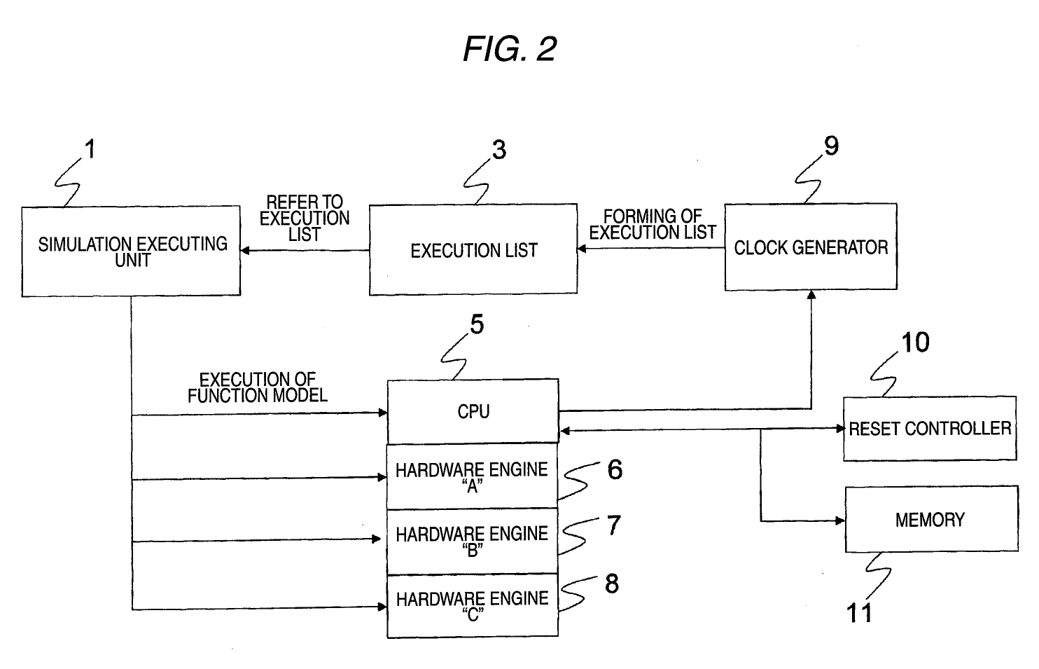

FIG. 2 indicates such a case that both an embodiment mode of the first invention and an embodiment mode of the second invention have been applied to the basic structure of the present invention, which is shown in FIG. 1. It is so designed that a function capable of forming an execution list 3 is given to a clock generator 9. The clock generator 9 executes a process operation upon receipt of an access by the CPU 5 in a similar manner to the conventional simulation method. If the conventional method is employed, then the clock generator 9 sets only a supply status of a clock. However, in the first and second embodiment modes, in response to notification such as an access from the CPU 5, the clock generator 9 checks changes in statuses of the respective hardware engines 6, 7, 8 so as to form the execution list 3. In other words, the clock generator 9 updates the content of the execution list 3 in a dynamic manner in connection with the notification sent from the CPU 5.

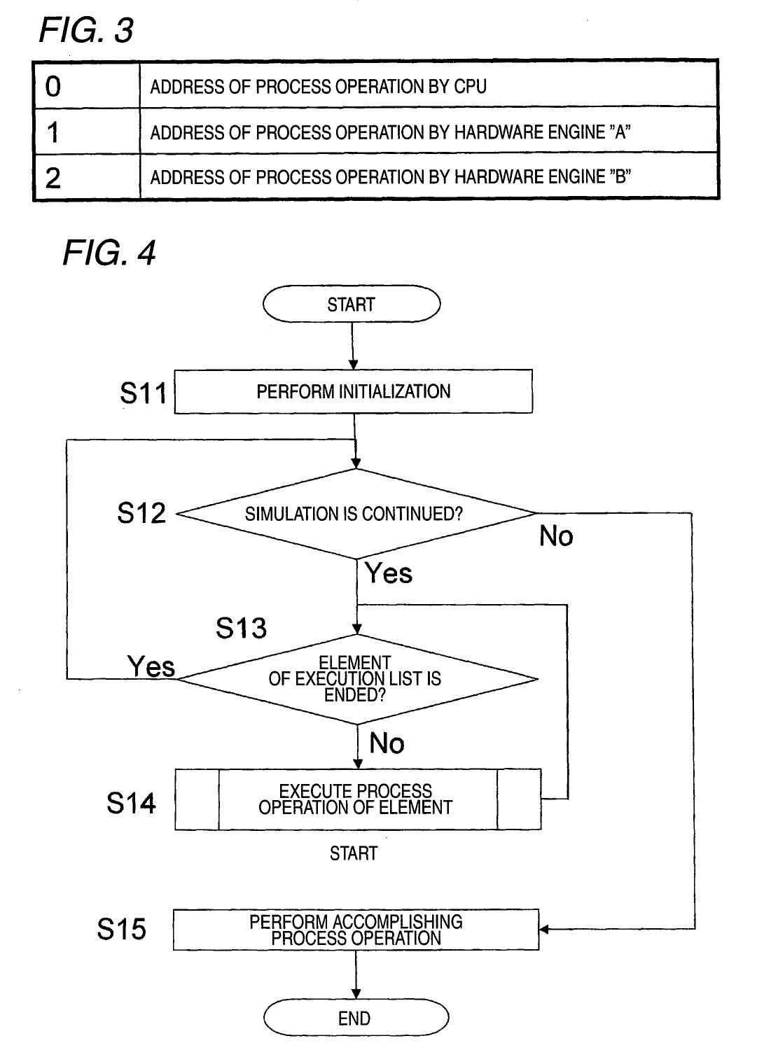

With respect to the CPU 5, it is so assumed that process addresses have been previously registered in the execution list 3 in an initializing process operation. FIG. 3 shows an example as to the execution list 3 to be formed. In FIG. 3, the CPU 5, the hardware engine“A”6, and the hardware engine“C”8 have been described in the execution list 3. In the execution list 3, an address of an executing process operation and the like have been described every element. It should be understood that the format of the execution list 3 is not limited only to the above-described format, but an optimum execution list may be utilized in conjunction with mounting of the simulation executing unit 1.

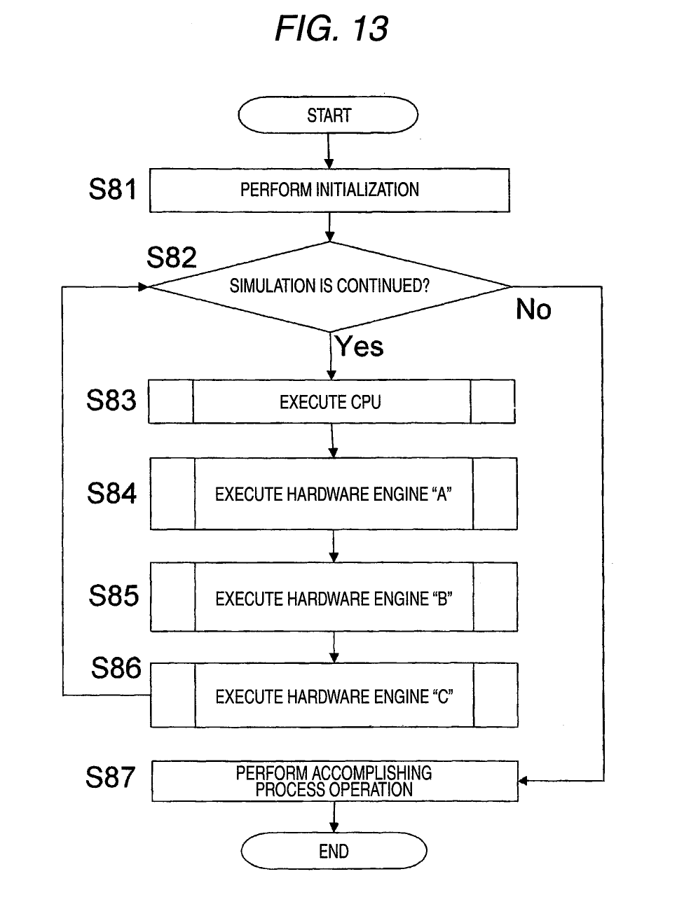

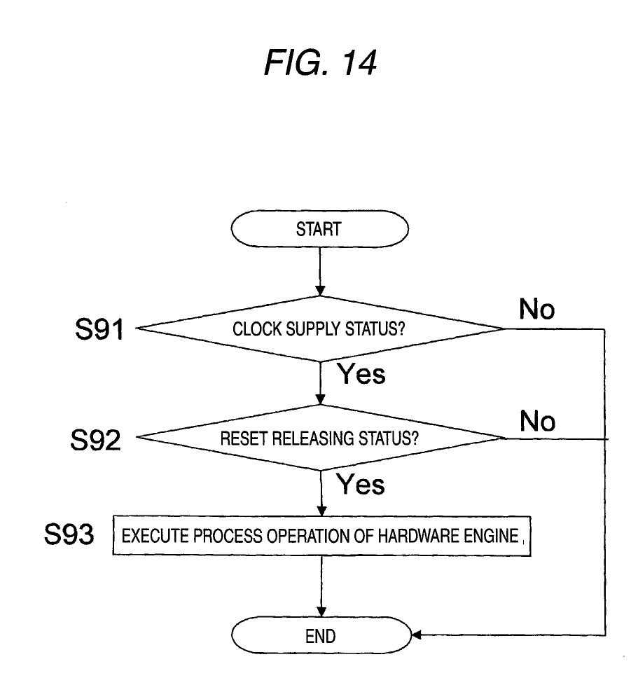

FIG. 4 indicates a flow chart for describing process operations of the simulation method according to the first and second embodiment modes. In comparison with the process flow operations of the conventional simulation method shown in FIG. 13, the process flow operations of the first and second embodiment modes are performed as follows: That is, the process operations related to the execution of the CPU 5 (step S83 of FIG. 13), the execution of the hardware engine“A” 6 (step S84), the execution of the hardware engine“B” 7 (step S85), and the execution of the hardware engine“C” 8 (step S86) constitute such an execution of a process operation for an element of the execution list 3 (step S14 of FIG. 4).

As to process operations of the main routine, in the conventional simulation method, the main routine has been executed by 4 sorts of these process operations (namely, execution of CPU 5: step S83; execution of hardware engine“A”: step S84; execution of hardware engine“B”: step S85; execution of hardware engine“C”: step S86) in the fixed manner, whereas in the first and second embodiment modes, the main routine is executed by an execution of the CPU 5 and an execution of an element formed by the clock generator 9 (step S14).

As a consequence, when the clock is not supplied and there is no element in the execution list 3, any of the hardware engine“A” 6, the hardware engine“B” 7, and the hardware engine“C” 8 is not executed.

In such a case that the clock is supplied only to the hardware engine“A” 6, only the hardware engine“A” 6 is executed, whereas in the case that the clocks are supplied to two sets of the hardware engine“A” 6 and the hardware engine“B” 7, two elements are executed.

As a consequence, the process operations which are executed in the main routine can be increased and/or decreased in conjunction with the supply status of the clock, and also, the processing speed can be increased in conjunction of the supply status of the clock.

In particular, under such a condition that the clock is not supplied to any of the hardware engine“A” 6, the hardware engine“B”7, and the hardware engine“C” 8, a process operation which should be executed corresponds only to the process operation of the CPU 5, so that the main routine can be executed in a higher speed.

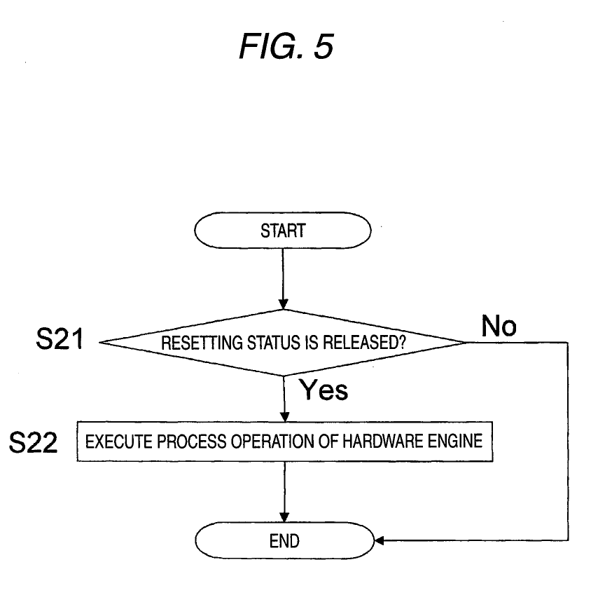

Also, FIG. 5 indicates a flow chart of process operations executed in any one of these hardware engines 6, 7, 8. If the conventional simulation method is carried out, then the supply status of the clock has been confirmed in this process flow. However, in the simulation method of the first and second embodiment modes, since there is such an initial condition that the clock has already been supplied at such a time instant when this process operation is executed, such a process operation for confirming the clock supply status can be eliminated in the above-explained process operations, resulting in a highspeed simulation.

Furthermore, as an embodiment mode of third invention, the above-described clock generator 9 is caused to acquire notification for updating a resetting status by receiving an access from the CPU 5 to a reset controller 10.

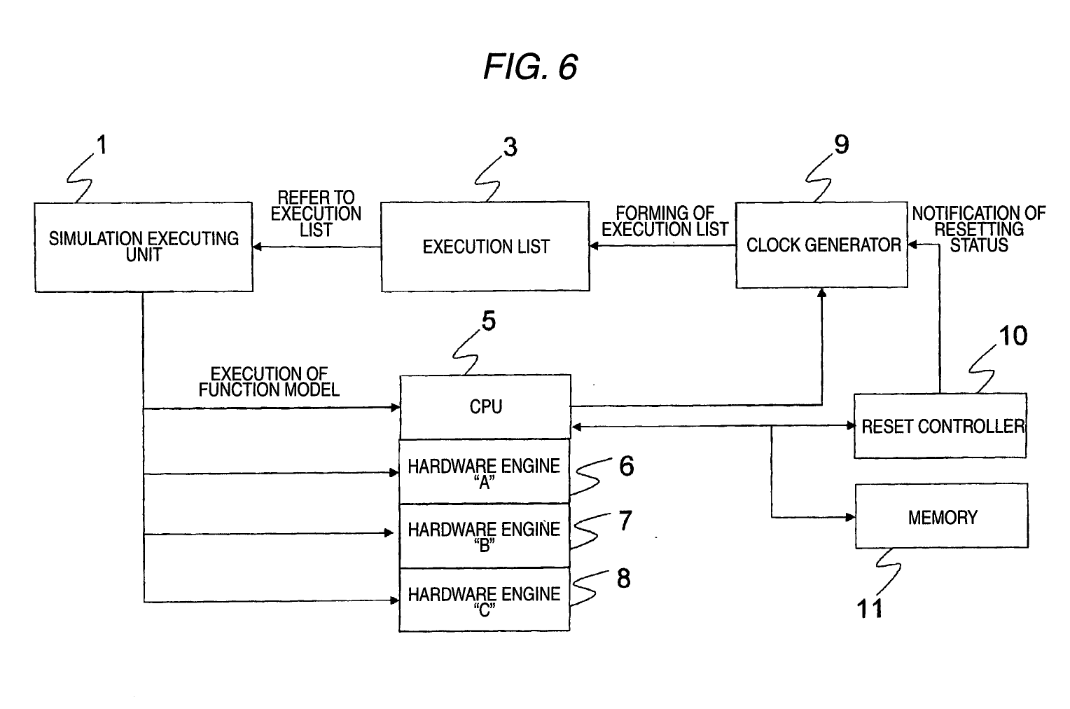

A structural diagram of this third invention is indicated in FIG. 6. A change in the resetting statuses by the access from the CPU 5 to the reset controller 10 is notified to the clock generator 9. Upon receipt of this notification, the clock generator 9 forms an execution list 3 in combination with the clock supply status.

In this third invention, under such a condition that the clock has been supplied and the resetting status has been released, an element is added to the execution list 3, whereas under such a condition that the supply of the clock is stopped, or the resetting status occurs, the element is deleted from the execution list 3.

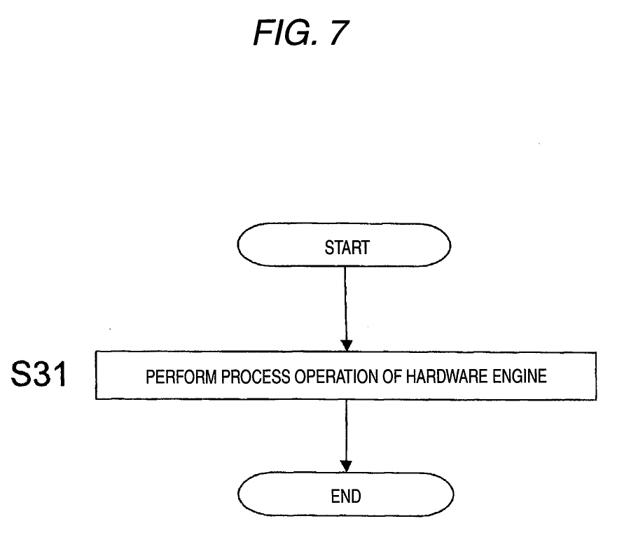

FIG. 7 is a flow chart for describing process operations of each of the hardware engines 6, 7, 8 at this time. As a result, since the execution list 3 can be formed by considering the clock supply status and the resetting status, the process operation related to checking of the resetting status can be furthermore deleted in FIG. 7 in comparison with the embodiment mode of the second invention.

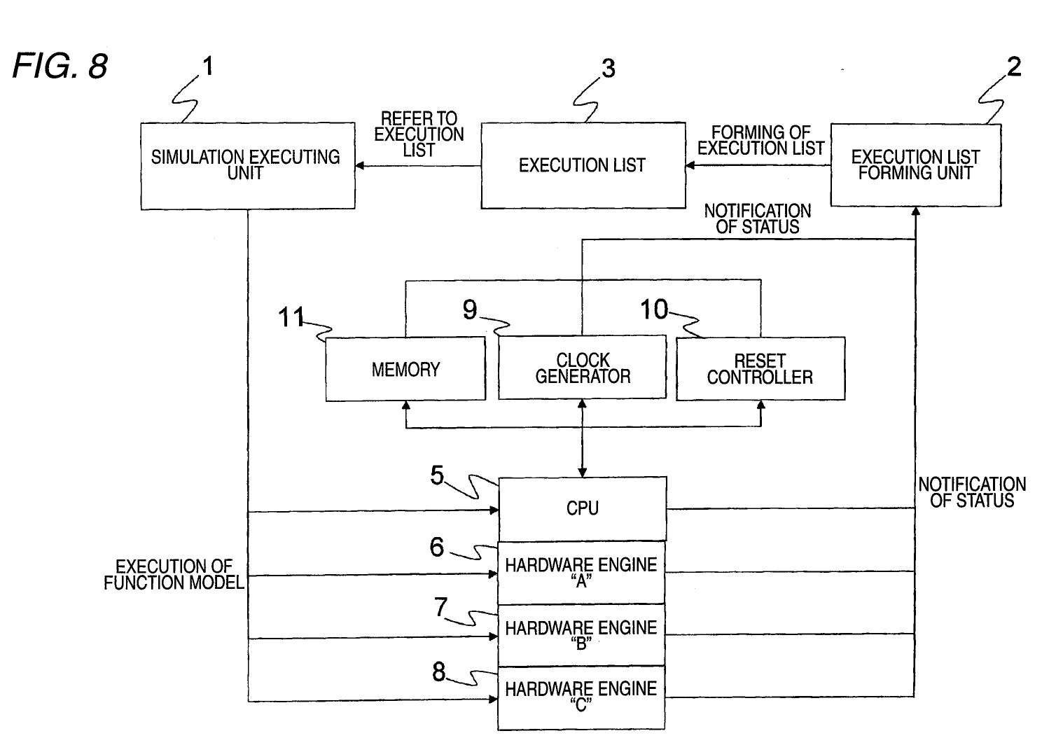

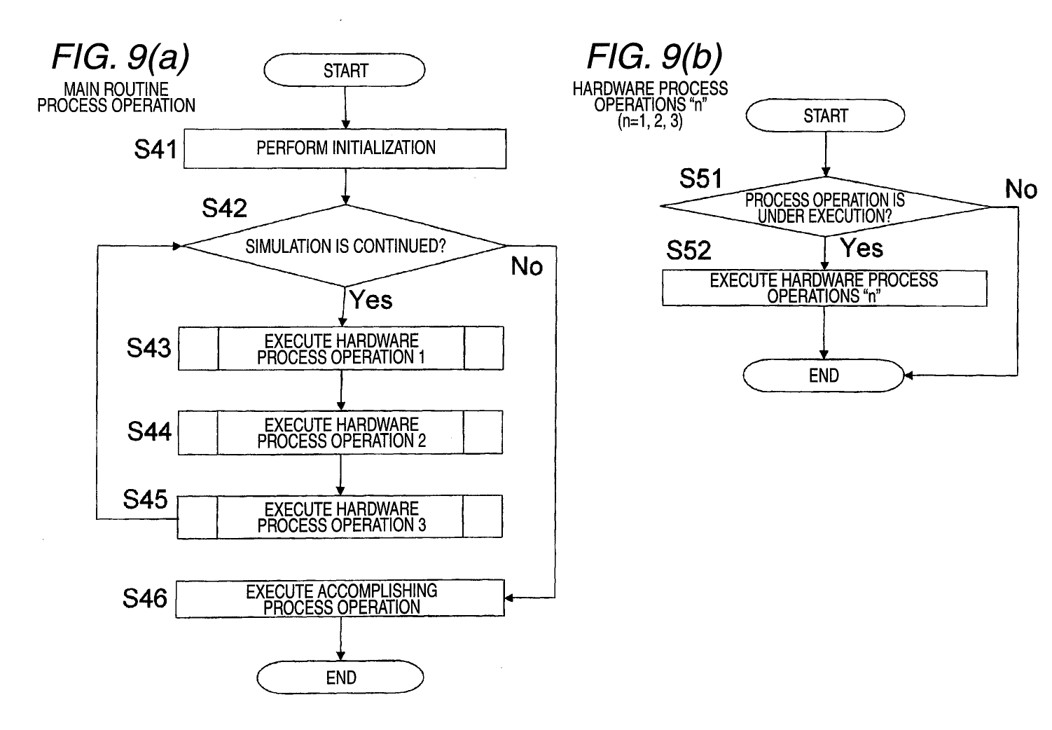

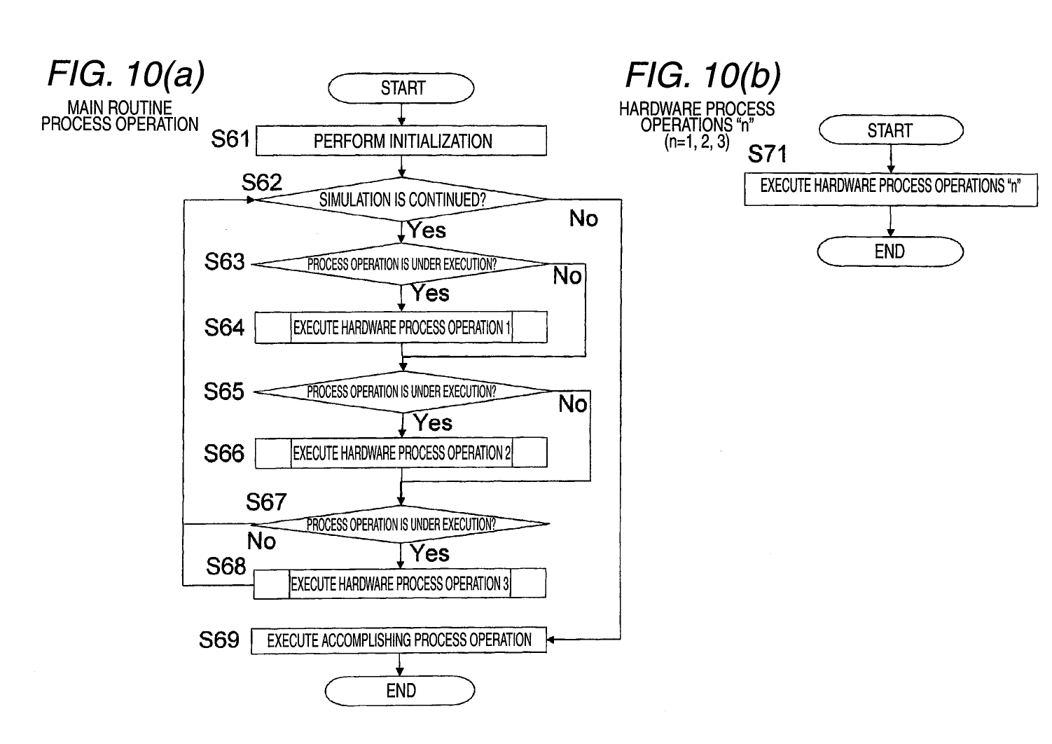

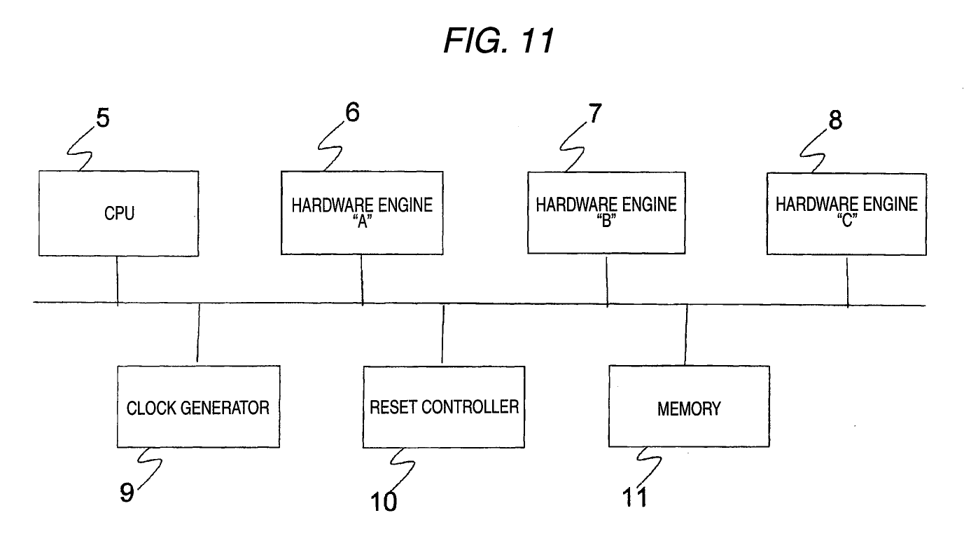

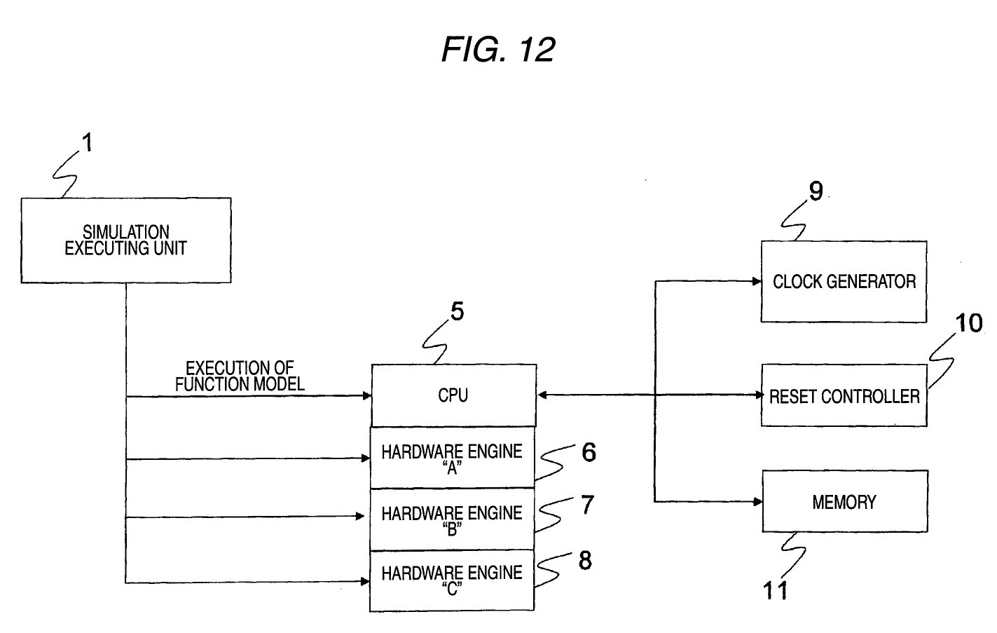

As an embodiment mode of fourth invention, the function capable of forming the execution list 3 is given to the clock generator 9 as another function. FIG. 8 shows a structural diagram of the above-described embodiment mode of the fourth invention. As a consequence, for instance, in addition to a clock supply status and a resetting status, statuses containing specific status setting conditions of the respective hardware engines 6, 7, 8 can be managed.

It should be noted that the above-described specific status setting condition of a hardware engine implies, for example, such a condition that this hardware engine is set to a sleep mode and thus does not execute a process operation, or such a condition that since an operation Enable has not been set to this hardware engine, the hardware engine is not operated.

Also, since this forming function is independently provided, the process operations to be executed in the clock generator 9 can be reduced, so that it is possible to eliminate that the process operations executed by the clock generator 9 become complex.

As an embodiment mode of fifth invention, a sleep status of the CPU 5 is simulated not only by the clock generator 9, but also by the reset controller 10. A structural diagram of this embodiment mode of the fifth invention is similar to that of FIG. 8.

As the CPU 5 utilized in the embodiment mode of the fifth invention, it is so assumed that since the CPU 5 executes a predetermined instruction, the operation status of this CPU 5 is brought into a sleep status. It is also assumed that the CPU 5 which has been entered to the sleep status does not execute all of process operations including an instruction execution until interrupt notification is issued from the hardware engines 6, 7, 8.

When the CPU 5 executes an instruction for entering the CPU 5 into the sleep status, the CPU 5 issues notification to the execution list forming unit 2. Upon receipt of this notification, the execution list forming unit 2 deletes the CPU 5 from the execution list 3. Thereafter, in the main routine, the execution list 3 is executed under such a condition that the CPU 5 is not present.

Assuming now such a condition that the CPU 5 is under sleep condition and the hardware engine“A” 6 is being operated, when the execution of the hardware engine“A” 6 is accomplished, an interrupt for the CPU 5 occurs. This interrupt is also notified to the execution list forming unit 2.

Upon receipt of this notification, the execution list forming unit 2 again adds the CPU 5 under the sleep condition to the execution list 3, and restarts the execution. The CPU 5 receives a recovery interrupt from the sleep condition, and restarts the operation from this interrupt process operation.

In accordance with the above-described embodiment modes, while the time concept is not abstracted, the execution list of the simulation is dynamically formed in response to the changes in the statuses of the hardware, for instance, the clock setting operation by the access from the software (CPU) and the initiation setting operation to the hardware block, and then, the simulation is carried out with reference to the formed execution list. As a result, while the simulation precision of the cycle base is maintained, the influence caused by the scale increase of the system LSI can be reduced, so that the simulation can be carried out in the high speed. As a consequence, while the simulation precision of the cycle level is maintained, the simulation as to the system LSI can be carried out in the high speed. In particular, such a large scaled and long time simulation which contains OS, device drivers, and middleware with employment of a presently available large-scaled and complex system LSI, and in which a block operated as a system is changed by setting the respective function blocks can be carried out in such a high speed approximated to the actual speed.

The simulation method according to the present invention can be performed in the high speed while the precision in the cycle level is maintained. The simulation apparatus and the simulation method, according to the present invention, are very useful in development of such an assembling system which utilizes the large-scaled hardware and large-scaled software, and also requires the real-time operation.

What is claimed is:

1. A simulation method for a system LSI (Large-Scaled Integration), comprising:
a step for forming a list of process operations by receiving notification as to a status of a system, said process operations being executed every cycle in response to the status of said system; and
a step for executing a process operation which is described in said formed list every time 1 cycle has elapsed.

2. The simulation method as claimed in claim 1 wherein: said list is formed in response to a status of a clock supplied to a function model.

3. The simulation method as claimed in claim 2 wherein:
said list is formed in response to a status of resetting of said function model.

4. The simulation method as claimed in claim 1 wherein:
upon receipt of notification of plural statuses related to the system, said list is formed in response to a combination of said plural statuses.

5. The simulation method as claimed in claim 4 wherein:
the notification of said plural statuses includes notification issued from a CPU (Central Processing Unit); and
an execution of said CPU is added to, or deleted from said list.

6. A simulation system for a system LSI, comprising:
an execution list forming unit for forming a list of process operations by receiving notification as to a status of a system, said process operations being executed every cycle in response to the status of said system; and
a simulation executing unit for executing a process operation which is described in said-formed list every time 1 cycle has elapsed.

7. The simulation system as claimed in claim 6, further comprising:
a clock generator for forming said list in response to a status of a clock supplied to a function model.

8. The simulation system as claimed in claim 7 wherein:
said simulation system is further comprised of a reset controller which notifies a resetting status of said function model to said clock generator; and
said clock generator forms said list in response to the resetting status of said function model.

9. The simulation system as claimed in claim 6 wherein:
upon receipt of notification of plural statuses related to the system, said execution list forming unit forms said list in response to a combination of said plural statuses.

10. The simulation system as claimed in claim 9 wherein:
said execution list forming unit forms said list in response to notification issued from a CPU.

11. A simulation program product for a system LSI embodied on a computer readable medium which, when executed by a computer, cause the computer to perform:
a function for forming a list of process operations by receiving notification as to a status of a system, said process operations being executed every cycle in response to the status of said system; and
a function for executing a process operation which is described in said formed list every time 1 cycle has elapsed.

12. The simulation program product as claimed in claim 11 wherein said list is formed in response to a status of a clock supplied to a function model.

13. The simulation program product as claimed in claim 12 wherein:
said list is formed in response to a status of resetting of said function model.

14. The simulation program product as claimed in claim 11 wherein:
upon receipt of notification of plural statuses related to the system, said list is formed in response to a combination of said plural statuses.

15. The simulation program product as claimed in claim 14 wherein:
the notification of said plural statuses includes notification issued from a CPU (Central Processing Unit); and
an execution of said CPU is added to, or deleted from said list.
